(19) United States
(12) Patent Application Publication
(10) Pub. No.: US 2025/0307831 A1
(43) Pub. Date: Oct. 2, 2025

(54) DIGITAL CUSTODY TRANSACTIONS

(71) Applicant: Vaultabo Inc., New York, NY (US)

(72) Inventor: Keith Derrick Kourie, Johannesburg (ZA)

(21) Appl. No.: 19/239,915

(22) Filed: Jun. 16, 2025

Related U.S. Application Data
(63) Continuation of application No. PCT/IB2023/062470, filed on Dec. 11, 2023.
(60) Provisional application No. 63/432,520, filed on Dec. 14, 2022.

(51) Int. Cl. G06Q 20/42; G06Q 20/36; G06Q 20/38; G06Q 20/40

(52) U.S. Cl. CPC G06Q 20/42; G06Q 20/36; G06Q 20/389; G06Q 20/40145; G06Q 20/405; G06Q 2220/10

(57) ABSTRACT

Systems and methods of initiating an asset receive transaction on a biometrically enabled receiving security device are provided. One exemplary method includes receiving an encrypted initiate receive transaction message from a remote initiator, the remote initiator being the holder of a biometrically enabled security device, receiving at least one encrypted authorize/verify receive transaction message from a remote authorizer, executing a receive transaction in accordance with the encrypted initiate and authorize/verify receive transaction message on a biometrically enabled receiving security device in the blockchain custody system and completing the receive transaction on the biometrically enabled receiving security device in the blockchain custody system.

### CROSS-REFERENCE TO RELATED APPLICATION INFORMATION

This is a continuation (bypass) of International application No. PCT/IB2023/062470, filed Dec. 11, 2023, published as WO2024/127208A1, and which claims benefit/priority to U.S. provisional application No. 63/432,520, filed Dec. 14, 2023, all of which are incorporated herein by reference in entirety.

### BACKGROUND

### Field

The disclosed technology relates to digital custody transactions. In particular, one implementation relates to a method of initiating an asset receive transaction.

### Description of Related Information

Modern digital transaction systems rely on blockchain technology to facilitate digital transactions. This technology is used increasingly in real world transactions to ensure independently verified secure transactions. Use of blockchain technology leads to the need for curation of blockchain assets by independent third parties.

The most significant growth in blockchain transactions has been in the market of smaller entities, which implies reduced unit value/increased volume transactions.

The adoption of blockchain assets has been in all goods and services markets such as legal firms, accounting firms, luxury goods market, exclusive art and the like.

However, as any blockchain asset is singular, the custody thereof is of critical importance and a combination of software and hardware custody systems are often preferred. The inventor therefore identified a need to provide a method to facilitate a blockchain transaction on a combination hardware/software custody system that is safe and secure, not vulnerable to attacks from hackers, only accessible by authorized parties and which provides adequate backup in event of failure.

### Overview

According to one aspect of the disclosed technology, in a blockchain custody system, there is provided a method of initiating an asset receive transaction on a biometrically enabled receiving security device, which includes
receiving an encrypted initiate receive transaction message from a remote initiator, the remote initiator being the holder of a biometrically enabled security device;
receiving at least one encrypted authorize/verify receive transaction message from a remote authorizer;
executing a receive transaction in accordance with the encrypted initiate and authorize/verify receive transaction message on a biometrically enabled receiving security device in the blockchain custody system; and
completing the receive transaction on the biometrically enabled receiving security device in the blockchain custody system.

The method may include prior to receiving an encrypted initiate receive transaction message from a remote initiator the step, by a remote initiator, of initiating the asset receive transaction.

The step of initiating the asset receive transaction by a remote initiator may include the following sequential steps:
a remote initiator logs into a custody system by means of a biometrically enabled security device;
a remote initiator selects an organization from a list of organizations to which the remote initiator has access;
a remote initiator selects an account from a list of accounts to which the remote initiator has access of the selected organization;
a remote initiator selects a wallet from a list of wallets to which the remote initiator has access of the selected accounts to which the remote initiator has access;
a remote initiator selects an asset from a list of assets to which the remote initiator has access of the selected wallets to which the remote initiator has access;
a remote initiator is presented with an asset balance and any other relevant information of the selected asset; and
a remote initiator confirms/authorizes the asset receive transaction on a biometrically enabled receiving security device.

The step of initiating the asset receive transaction may include the step of displaying and editing customizable fields to a remote initiator.

The step of initiating the asset receive transaction may include the additional step of displaying custom field values.

The additional step of displaying custom field values may display custom field values for a particular secure account.

The step of initiating the asset receive transaction may then include the additional step of entering and/or selecting custom field values after the step of displaying custom field values.

The step of authorizing the asset receive transaction may include the following sequential steps:
a remote authorizer logs into a custody system by means of a biometrically enabled security device;
a remote authorizer selects an organization from a list of organizations to which the remote authorizer has access;
a remote authorizer selects a pending receive transaction from a list of pending receive transactions;
a remote authorizer view details of the selected pending receive transaction;
a remote authorizer then confirm/authorize the receive transaction by means of a biometrically enabled security device.

The step of authorizing the asset receive transaction may include the additional step of displaying custom field values to the remote authorizer. The step of authorizing the asset receive transaction may then also include the step of entering custom field values.

The step of executing a receive transaction in accordance with the encrypted initiate receive transaction message may include the following sequential steps:
the blockchain custody system receives the encrypted initiate receive transaction;
the blockchain custody system receives the encrypted authorize/verify receive transaction messages;
optionally, the blockchain custody system checks the receive transaction against policy rules and predefined values;
an executor logs onto the custody system by means of a biometrically enabled security device;
the executor selects an organization from a list of organizations to which the executor has access;
the executor selects a pending Authorized/Verified receive transaction to execute;
optionally, custom field values are displayed to the executor;
details of the pending authorized/verified receive transaction including the destination address is displayed to the executor;
optionally, the executor enters optional custom field values for the receive transaction;
the blockchain custody system sends encrypted messages and data to the biometrically enabled receiving security device (that is to receive the blockchain asset);
the biometrically enabled receiving security device authenticates and verifies all data messages and checks the receive transaction against policy rules and predefined values;
following successful authentication and verification of the encrypted messages and data, the biometrically enabled receiving security device internally creates a destination address and returns this destination address to the blockchain custody system; and
the executor generates the blockchain transaction on the relevant system.

An executor is defined as a role which has permission to execute a previously authorized/verified receive transaction.

The step of completing the receive transaction on the blockchain custody system in the method of initiating an asset receive transaction may include the following sequential steps:
if the transaction ID was entered by the executor, monitoring the blockchain transaction being sent for mining until the required threshold number of transaction confirmations have been met;
either marking the receive transaction as complete once the required number of transaction confirmations have been met, or automatically marking the receive transaction as complete if the executor marked the receive transaction as complete.

The disclosed technology is now described, by way of non-limiting examples, with reference to the accompanying figures:

### BRIEF DESCRIPTION OF THE DRAWINGS

In the figure(s):

FIG. 1 shows a high-level schematic flow diagram of a method of initiating an asset receive transaction;

FIG. 2 shows an implementation architecture of a blockchain custody system in accordance with one aspect of the disclosed technology;

FIG. 3 shows the steps of initiating the asset receive transaction by a remote initiator in the method of FIG. 1;

FIG. 4 shows the steps of authorizing the asset receive transaction in the method of FIG. 1;

FIG. 5 shows the steps of executing a receive transaction in the method of FIG. 1; and

FIG. 6 shows the steps of completing the receive transaction in the method of FIG. 1.

In the figures, like reference numerals denote like parts of the disclosed technology unless otherwise indicated.

### DETAILED DESCRIPTION OF ILLUSTRATIVE EMBODIMENTS

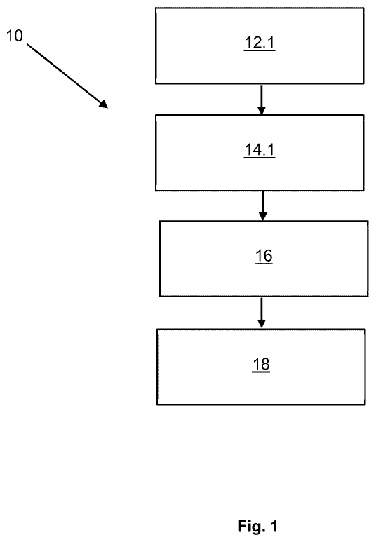

In FIG. 1 a schematic flow diagram of a method of initiating an asset receive transaction (10) in a blockchain custody system, is shown.

In the method of initiating an asset receive transaction (10), which is implemented in a blockchain custody system, the method is initiated by receiving an encrypted initiate receive transaction message at (12.1) from a remote initiator, the remote initiator being the holder of a biometrically enabled security device.

The system then receives an encrypted authorize/verify receive transaction message from at least one remote authorizer at (14.1), then executes a receive transaction on a biometrically enabled receiving security device in the blockchain custody system in accordance with the encrypted initiate receive transaction message at (16) and terminates by completing the receive transaction on the biometrically enabled receiving security device in the blockchain custody system at (18).

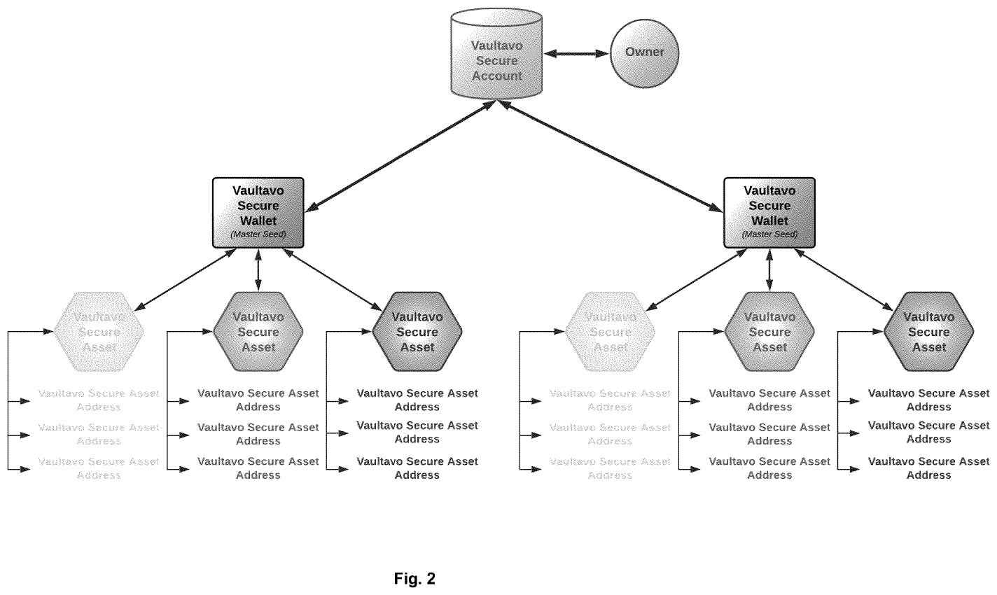

FIG. 2 shows an implementation architecture of a blockchain custody system on which the method if initiating an asset receive transaction is performed.

The method includes prior to receiving an encrypted initiate receive transaction message from a remote initiator at (12.1) the step, by a remote initiator, of initiating the asset receive transaction (not shown).

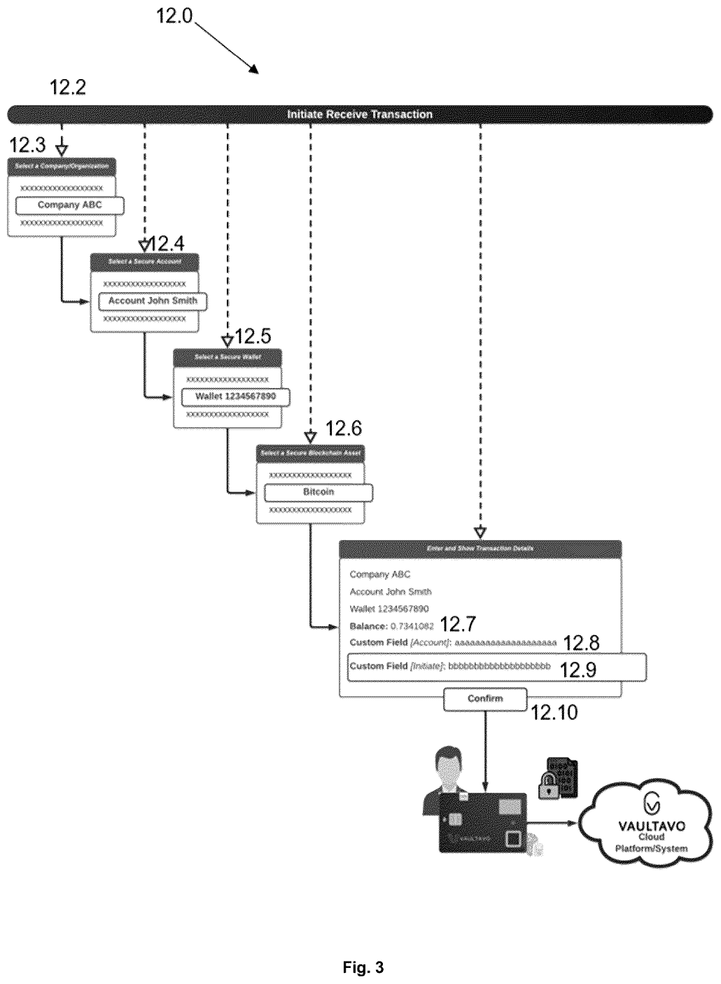

The step of initiating the asset receive transaction by a remote initiator is shown in FIG. 3 and includes the following sequential steps:
At (12.2) a remote initiator logs into a custody system by means of a biometrically enabled security device;
At (12.3) a remote initiator selects an organization from a list of organizations to which the remote initiator has access;
At (12.4) a remote initiator selects an account from a list of accounts to which the remote initiator has access of the selected organization;
At (12.5) a remote initiator selects a wallet from a list of wallets to which the remote initiator has access of the selected accounts to which the remote initiator has access;
At (12.6) a remote initiator selects an asset from a list of assets to which the remote initiator has access of the selected wallets to which the remote initiator has access;
At (12.7) a remote initiator is presented with a balance and any other relevant information of the selected asset;
At (12.8) a remote initiator is presented with custom field values for a particular secure account and/or secure wallet and/or asset (this is an optional step in certain conditions);
At (12.9) a remote initiator is presented with the opportunity of entering and/or selecting custom field values (this is an optional step in certain conditions); and
At (12.10) a remote initiator confirm/authorize the asset receive transaction.

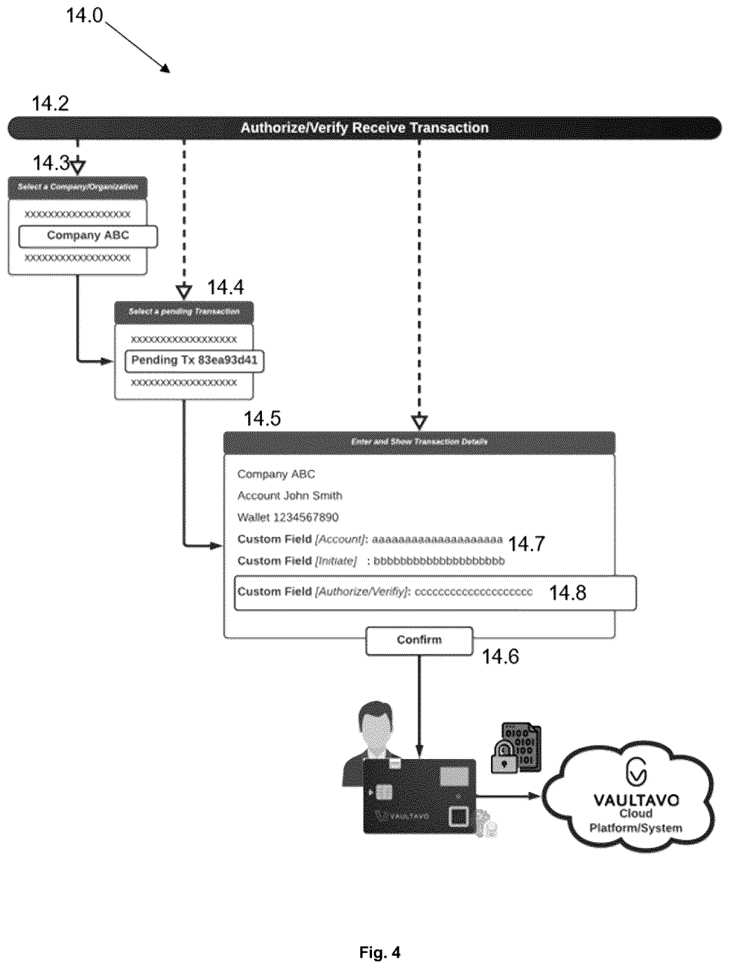

A step of authorizing the asset receive transaction (14.0) includes the following sequential steps, that are shown in FIG. 4:
At (14.2) a remote authorizer logs into a custody system with a biometrically enabled security device;
At (14.3) a remote authorizer selects an organization from a list of organizations to which the remote authorizer has access;
At (14.4) a remote authorizer selects a pending receive transaction from a list of pending receive transactions;
At (14.5) a remote authorizer view details of the selected pending receive transaction.

The step of authorizing the asset receive transaction (14.0) includes the additional (and optional) step at (14.7) of displaying custom field values to the remote authorizer. The step of authorizing the asset receive transaction also includes the (optional) step of entering and/or selecting custom field values at (14.8).

At (14.6) a remote authorizer then confirm/authorize the receive transaction.

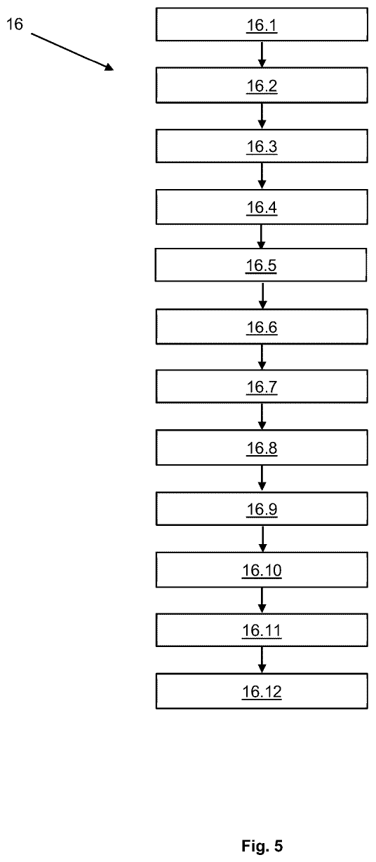

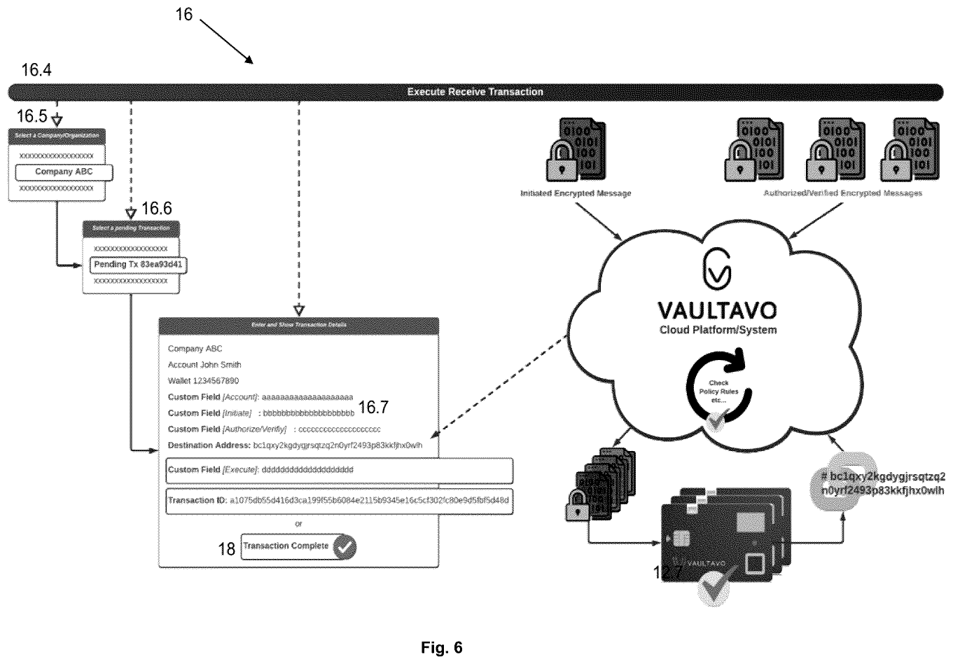

FIG. 5 shows the step of executing a receive transaction (16) in accordance with the method (10) in detail and FIG. 6 shows the step of executing a receive transaction (16) in accordance with the method (10) in summary.

An executor is defined as a role which has permission to execute a previously authorized/verified receive transaction, and/or to allow an authorized person to execute a previously authorized/verified receive transaction. The step of executing a receive transaction (16) in accordance with the encrypted receive transaction message is performed by an executor.

The step of executing a receive transaction (16) in accordance with the encrypted receive transaction message includes the following sequential steps:
At (16.1) the blockchain custody system receives the encrypted initiate receive transaction;
At (16.2) the blockchain custody system receives the encrypted authorize verify receive transaction messages;
At (16.3) the blockchain custody system (optionally) checks the receive transaction against policy rules and predefined values;
At (16.4) an executor logs onto the custody system by means of a biometrically enabled security device;
At (16.5) the executor selects an organization from a list of organizations to which the executor has access;
At (16.6) the executor selects a pending Authorized/Verified receive transaction to execute;
At (16.7) optionally, custom field values are displayed to the executor;
At (16.8) details of the pending authorized receive transaction is displayed to the executor;
At (16.9) the blockchain custody system sends encrypted messages and data to the biometrically enabled security device that is to receive the blockchain asset;
At (16.10) the biometrically enabled security device that is to receive the blockchain asset authenticates and verifies the encrypted messages and data and checks the receive transaction against policy rules and predefined values;
At (16.11) following successful authentication and verification of the encrypted messages and data, the biometrically enabled receiving security device creates a destination address(es) and returns these destination addresses to the blockchain custody system;
At (16.12) optionally, the executor enter and/or selects optional custom field values for the receive transaction.

The step (18) of completing the receive transaction on the blockchain custody system in the method of initiating an asset receive transaction includes the following sequential steps:
if the transaction ID was entered by the executor, monitoring the blockchain transaction being sent for mining until the required threshold number of transaction confirmations have been met; or by
either marking the receive transaction as complete once the required number of transaction confirmations have been met, or automatically marking the receive transaction as complete if the executor marked the receive transaction as complete.

The disclosed technology provides a novel method of initiating an asset receive transaction which will be of particular use in a method to facilitate a blockchain transaction on a combination hardware/software custody system that is safe and secure, not vulnerable to attacks from hackers, only accessible by authorized parties and which provides adequate backup in event of failure.

1. A method of initiating an asset receive transaction on a biometrically enabled receiving security device, which includes
receiving an encrypted initiate receive transaction message from a remote initiator, the remote initiator being the holder of a biometrically enabled security device;
receiving at least one encrypted authorize/verify receive transaction message from a remote authorizer;
executing a receive transaction in accordance with the encrypted initiate and authorize/verify receive transaction message on a biometrically enabled receiving security device in the blockchain custody system; and
completing the receive transaction on the biometrically enabled receiving security device in the blockchain custody system.

2. The method of claim 1 or the invention of any claim herein, which includes prior to receiving an encrypted initiate receive transaction message from a remote initiator the step, by a remote initiator, of initiating the asset receive transaction.

3. The method of claim 2 or the invention of any claim herein, in which the step of initiating the asset receive transaction by a remote initiator includes one or more of the following sequential steps:
a remote initiator logs into a custody system by means of a biometrically enabled security device;
a remote initiator selects an organization from a list of organizations to which the remote initiator has access;
a remote initiator selects an account from a list of accounts to which the remote initiator has access of the selected organization;
a remote initiator selects a wallet from a list of wallets to which the remote initiator has access of the selected accounts to which the remote initiator has access;
a remote initiator selects an asset from a list of assets to which the remote initiator has access of the selected wallets to which the remote initiator has access;
a remote initiator is presented with an asset balance and any other relevant information of the selected asset; and
a remote initiator confirms/authorizes the asset receive transaction on a biometrically enabled receiving security device.

4. The method of claim 3 or the invention of any claim herein, in which the step of initiating the asset receive transaction includes the step of displaying and editing customizable fields to a remote initiator.

5. The method of claim 4 or the invention of any claim herein, in which the step of initiating the asset receive transaction includes the additional step of displaying custom field values.

6. The method of claim 5 or the invention of any claim herein, in which the additional step of displaying custom field values includes displaying custom field values for a particular secure account.

7. The method of claim 6 or the invention of any claim herein, in which the step of initiating the asset receive transaction includes the additional step of entering and/or selecting custom field values after the step of displaying custom field values.

8. The method of claim 3 or the invention of any claim herein, in which the step of authorizing the asset receive transaction includes the following sequential steps:
a remote authorizer logs into a custody system by means of a biometrically enabled security device;
a remote authorizer selects an organization from a list of organizations to which the remote authorizer has access;
a remote authorizer selects a pending receive transaction from a list of pending receive transactions;
a remote authorizer view details of the selected pending receive transaction;
a remote authorizer then confirm/authorize the receive transaction by means of a biometrically enabled security device.

9. The method of claim 8 or the invention of any claim herein, in which the step of authorizing the asset receive transaction includes the additional step of displaying custom field values to the remote authorizer.

10. The method of claim 9 or the invention of any claim herein, in which the step of authorizing the asset receive transaction includes the step of entering custom field values.

11. The method of claim 10 or the invention of any claim herein, in which the step of executing a receive transaction in accordance with the encrypted initiate receive transaction message includes the following sequential steps:
the blockchain custody system receives the encrypted initiate receive transaction;
the blockchain custody system receives the encrypted authorize/verify receive transaction messages;
optionally, the blockchain custody system checks the receive transaction against policy rules and predefined values;
an executor logs onto the custody system by means of a biometrically enabled security device;
the executor selects an organization from a list of organizations to which the executor has access;
the executor selects a pending Authorized/Verified receive transaction to execute;
optionally, custom field values are displayed to the executor;
details of the pending authorized/verified receive transaction including the destination address is displayed to the executor;
optionally, the executor enters optional custom field values for the receive transaction;
the blockchain custody system sends encrypted messages and data to the biometrically enabled receiving security device (that is to receive the blockchain asset);
the biometrically enabled receiving security device authenticates and verifies all data messages and checks the receive transaction against policy rules and predefined values;
following successful authentication and verification of the encrypted messages and data, the biometrically enabled receiving security device internally creates a destination address and returns this destination address to the blockchain custody system; and
the executor generates the blockchain transaction on the relevant system.

12. The method of claim 10 or the invention of any claim herein, in which the step of completing the receive transaction on the blockchain custody system in the method of initiating an asset receive transaction includes the following sequential steps:
if the transaction ID was entered by the executor, monitoring the blockchain transaction being sent for mining until the required threshold number of transaction confirmations have been met;
either marking the receive transaction as complete once the required number of transaction confirmations have been met, or automatically marking the receive transaction as complete if the executor marked the receive transaction as complete.

13. A system comprising:
at least one processor;
one or more non-transitory computer readable media in operative communication with the at least one processor, the non-transitory computer readable media having stored thereon computer readable instructions that, upon execution by the at least one processor, cause the at least one processor to:
initiate an asset receive transaction on a biometrically enabled receiving security device;
receive an encrypted initiate receive transaction message from a remote initiator, the remote initiator being the holder of a biometrically enabled security device;
receive at least one encrypted authorize/verify receive transaction message from a remote authorizer;
execute a receive transaction in accordance with the encrypted initiate and authorize/verify receive transaction message on a biometrically enabled receiving security device in the blockchain custody system; and
complete the receive transaction on the biometrically enabled receiving security device in the blockchain custody system.

14. The system of claim 13 or the invention of any claim herein, which includes prior to receiving an encrypted initiate receive transaction message from a remote initiator the step, by a remote initiator, of initiating the asset receive transaction.

15. The system of claim 14 or the invention of any claim herein, in which the initiating the asset receive transaction by a remote initiator includes one or more of the following sequential steps:
a remote initiator logs into a custody system by means of a biometrically enabled security device;
a remote initiator selects an organization from a list of organizations to which the remote initiator has access;
a remote initiator selects an account from a list of accounts to which the remote initiator has access of the selected organization;
a remote initiator selects a wallet from a list of wallets to which the remote initiator has access of the selected accounts to which the remote initiator has access;
a remote initiator selects an asset from a list of assets to which the remote initiator has access of the selected wallets to which the remote initiator has access;
a remote initiator is presented with an asset balance and any other relevant information of the selected asset; and
a remote initiator confirms/authorizes the asset receive transaction on a biometrically enabled receiving security device.

16. The system of claim 15 or the invention of any claim herein, wherein the initiating the asset receive transaction includes the step of displaying and editing customizable fields to a remote initiator.

17. The system of claim 16 or the invention of any claim herein, wherein the initiating the asset receive transaction includes the additional step of displaying custom field values.

18. The system of claim 17 or the invention of any claim herein, wherein the displaying custom field values includes displaying custom field values for a particular secure account.

19. The system of claim 18 or the invention of any claim herein, wherein the initiating the asset receive transaction includes the additional step of entering and/or selecting custom field values after the step of displaying custom field values.

20. The system of claim 15 or the invention of any claim herein, wherein the authorizing the asset receive transaction includes the following steps:
a remote authorizer logs into a custody system by means of a biometrically enabled security device;
a remote authorizer selects an organization from a list of organizations to which the remote authorizer has access;
a remote authorizer selects a pending receive transaction from a list of pending receive transactions;
a remote authorizer view details of the selected pending receive transaction;
a remote authorizer then confirm/authorize the receive transaction by means of a biometrically enabled security device.

21. The system of claim 20 or the invention of any claim herein, wherein the authorizing the asset receive transaction includes an additional step of displaying custom field values to the remote authorizer.

22. The system of claim 21 or the invention of any claim herein, wherein the authorizing the asset receive transaction includes a step of entering custom field values.

23. The system of claim 22 or the invention of any claim herein, wherein the executing a receive transaction in accordance with the encrypted initiate receive transaction message includes the following steps:
the blockchain custody system receives the encrypted initiate receive transaction;
the blockchain custody system receives the encrypted authorize/verify receive transaction messages;
optionally, the blockchain custody system checks the receive transaction against policy rules and predefined values;
an executor logs onto the custody system by means of a biometrically enabled security device;
the executor selects an organization from a list of organizations to which the executor has access;
the executor selects a pending Authorized/Verified receive transaction to execute;
optionally, custom field values are displayed to the executor;
details of the pending authorized/verified receive transaction including the destination address is displayed to the executor;
optionally, the executor enters optional custom field values for the receive transaction;
the blockchain custody system sends encrypted messages and data to the biometrically enabled receiving security device (that is to receive the blockchain asset);
the biometrically enabled receiving security device authenticates and verifies all data messages and checks the receive transaction against policy rules and predefined values;
following successful authentication and verification of the encrypted messages and data, the biometrically enabled receiving security device internally creates a destination address and returns this destination address to the blockchain custody system; and
the executor generates the blockchain transaction on the relevant system.

24. The system of claim 22 or the invention of any claim herein, wherein the completing the receive transaction on the blockchain custody system includes the following steps:
if the transaction ID was entered by the executor, monitoring the blockchain transaction being sent for mining until the required threshold number of transaction confirmations have been met;
either marking the receive transaction as complete once the required number of transaction confirmations have been met, or automatically marking the receive transaction as complete if the executor marked the receive transaction as complete.
